(19) United States
(12) Patent Application Publication
(10) Pub. No.: US 2012/0119484 A1
(43) Pub. Date: May 17, 2012

(54) SYSTEM AND METHOD FOR COUPLING PIPES

(75) Inventors: Thomas Kilpatrick McLaughlin, Balmedie (GB); Joe Lynn Yates, Odessa, TX (US); Jon Knowlton Peterson, Friendswood, TX (US)

(73) Assignee: NATIONAL OILWELL VARCO, L.P., Houston, TX (US)

(21) Appl. No.: 13/356,323

(22) Filed: Jan. 23, 2012

Related U.S. Application Data
(63) Continuation-in-part of application No. 12/756,389, filed on Apr. 8, 2010.
Application No. 12/756,389 is a continuation of application No. 11/540,939, filed on Sep. 29, 2006, now Pat. No. 7,731,246.
Application No. 11/540,939 is a continuation-in-part of application No. 12/756,448, filed on Apr. 8, 2010.
Application No. 12/756,448 is a continuation of application No. 11/540,939, filed on Sep. 29, 2006, now Pat. No. 7,731,246.
(60) Provisional application No. 61/436,876, filed on Jan. 27, 2011.

(51) Int. Cl. F16L 39/00; B23P 11/00

(52) U.S. Cl. 285/55; 29/525.02

(57) ABSTRACT

A system and method for coupling pipes. The system includes at least one tubular sleeve positionable in at least one of the pair of pipes and a compression ring. Each of the tubular sleeves has a ring end. The compression ring is positionable in the coupling and has having a ring shoulder positionable adjacent a ring end of the at least one tubular sleeve for selective engagement therewith such that, as fluid passes through the compression ring and the at least one tubular sleeve, fluid is selectively releaseable therebetween.

### CROSS REFERENCE TO RELATED APPLICATION

This patent application claims priority to U.S. Provisional patent application Ser. No. 61/436,876 filed on Jan. 27, 2011 entitled “SYSTEM AND METHOD FOR COUPLING PIPES,” the entire contents of which are hereby incorporated by reference herein. This application also is a continuation-in-part of U.S. Non-Provisional patent application Ser. No. 12/756,448 filed on Apr. 8, 2010 and U.S. Non-Provisional patent application Ser. No. 12/756,389 filed on Apr. 8, 2010, both of which are continuations of issued U.S. Pat. No. 7,731,246, the entire contents of which are hereby incorporated by reference herein.

### BACKGROUND

The present disclosure relates generally to techniques for transporting fluids. In particular, the present disclosure relates to techniques for coupling and/or protecting pipes (and/or other tubulars) used in transporting fluids.

The gathering of valuable hydrocarbons from subsurface reservoirs may involve deploying downhole tools, such as drilling tools, from a surface oil rig and into a subterranean formation. Once a desired formation is reached, the drilling tools may be retrieved, and a tubing string extended from the surface to the subsurface reservoir to provide a passage for transporting fluids or gasses. The tubing string may be made up of a series of individual pipes (sometimes referred to as tubulars) threaded together end to end to form a long tubular chain. The pipes may be joined together using a coupling threaded to the ends of each pipe. Examples of couplings used for coupling pipes are described in U.S. Pat. Nos. 5,689,871, 4,600,219, 3,266,821, 4,568,113, 3,266,821, 2,805,827, and 2,487,241.

The pipes may be provided with liners to protect them from corrosive fluids or gasses passing therethrough. However, in some cases, a gap may exist in the liners at the coupling where pipes are connected. Devices, such as corrosion rings or gaskets, have been used about coupling assemblies as described in U.S. Pat. Nos. 7,360,797 and 4,856,828. Despite the development of techniques for coupling pipes, there remains a need to provide devices that are operable in even the harshest downhole conditions.

### SUMMARY

The present disclosure relates to systems and methods for coupling pipes. In at least one aspect, the disclosure provides a liner system for a tubular string including a coupling threadedly connectable to a pair of pipes for forming a threaded connection therebetween. The liner system includes at least one tubular sleeve and a compression ring. The tubular sleeve is positionable in at least one of the pipes and each of the tubular sleeves has a ring end. The compression ring is positionable in the coupling and has a ring shoulder positionable adjacent a ring end of the tubular sleeve for selective engagement therewith such that, as fluid passes through the compression ring and the one tubular sleeve, fluid is selectively releaseable therebetween.

The liner system further includes a liner positionable in at least one of the pipes and extends through at least a portion of the tubular sleeve. The tubular sleeve includes a liner extending therefrom and into one of the pipes. The compression ring has a linear, curved, and/or asymmetrical cross-section. The tubular sleeve includes a flange sleeve having a ring body with a flange ring at the ring end thereof. Each of the flange rings are positionable adjacent one of the ring shoulders of the compression ring. The flange ring defines a flange shoulder about an inner diameter of the flange sleeve for receivingly engaging a liner. The tubular sleeve includes a flexible sleeve having a ring body with an end face at the ring end thereof. The end face of the flexible sleeve is positionable adjacent one of the ring shoulders of the compression ring.

The liner system may also include a shoulder portion on an inner diameter thereof defining a flexible shoulder for receivingly engaging a liner, or a bonding agent for securing the one sleeve in place. The bonding agent may be a cement and/or an adherent. A pair of sleeves may be positionable in each of the pipes and adjacent one of the ring shoulders of the compression ring. The sleeve may be made of polyetheretherketone, glass reinforced epoxy, polytetrafluoroethylene, elastomer, thermoplastic, glass reinforced, rubber, and/or polythalamide.

In another aspect, the disclosure relates to a system fbr coupling a pair of pipes of a tubular string a coupling threadedly connectable to the pipes for forming a threaded connection therebetween. The system includes a liner system and a compression ring. The liner system includes at least one tubular sleeve posifionable in at least one of the pipes, with each of the one tubular sleeves having a ring end. The compression ring is positionable in the coupling and has a ring shoulder positionable adjacent a ring end of the one tubular sleeve for selective engagement therewith such that, as fluid passes through the compression ring and the one tubular sleeve, fluid is selectively releaseable therebetween.

The system further includes a liner positionable in each of the plurality of pipes and a bonding agent for bonding the tubular sleeve in place. The liner extends into at least a portion of the tubular sleeve.

In another aspect, the disclosure relates to a method for coupling a pair of pipes of a tubular string. The method involves providing a coupling threadedly connectable to the pair of pipes and a liner system. The liner system includes a compression ring and at least one tubular sleeve. The method further involves inserting the tubular sleeve in at least one of the pipes, threadedly connecting the coupling to one of the pipes, inserting the compression ring into the coupling such that a ring shoulder of the coupling ring is pressed against the tubular sleeve, threadedly connecting another of the pipes to the coupler, and selectively releasing fluid between the ring shoulder and the tubular sleeve as fluid passes through the liner system.

The method may also involve inserting at least one liner in the pipes, inserting the liner into the sleeve, positioning the liner against a shoulder of the flexible sleeve, passing fluid under pressure through the pipes and the liner system and/or applying a bonding to the liner system.

### BRIEF DESCRIPTION OF THE DRAWINGS

So that the above recited features and advantages of the present disclosure can be understood in detail, a more particular description of the disclosure, briefly summarized above, may be had by reference to the embodiments thereof that are illustrated in the appended drawings. It is to be noted, however, that the appended drawings illustrate only typical embodiments of this disclosure and are, therefore, not to be considered limiting of its scope, for the disclosure may admit to other equally effective embodiments. The figures are not necessarily to scale, and certain features and certain views of the figures may be shown exaggerated in scale or in schematic in the interest of clarity and conciseness.

FIG. 1 shows a schematic view (partially in cross-section) of a portion of a tubing string having a system for coupling pipes in accordance with the disclosure.

FIG. 2A shows a longitudinal, cross-sectional view of a portion of the tubing string and system for coupling pipes of FIG. 1, the system having a compression ring. FIG. 2B shows a portion of an alternate compression ring. FIG. 2C shows a cross-sectional view of the compression ring of FIG. 2B.

FIG. 3 is a flow chart depicting a method for coupling pipes.

### DETAILED DESCRIPTION

The description that follows includes exemplary apparatuses, methods, techniques, and instruction sequences that embody techniques of the present subject matter. However, it is understood that the described embodiments may be practiced without these specific details.

It may be desirable to provide techniques that control leakage about the pipes and/or coupling. It may further be desirable to provide techniques that reduce the load about the pipes and/or coupling. Preferably, such techniques involve one or more of the following, among others: distribution and/or absorption of loads, selective leakage of fluid, easy assembly, operability with a variety of pipes, protection of pipes and/or couplings, etc.

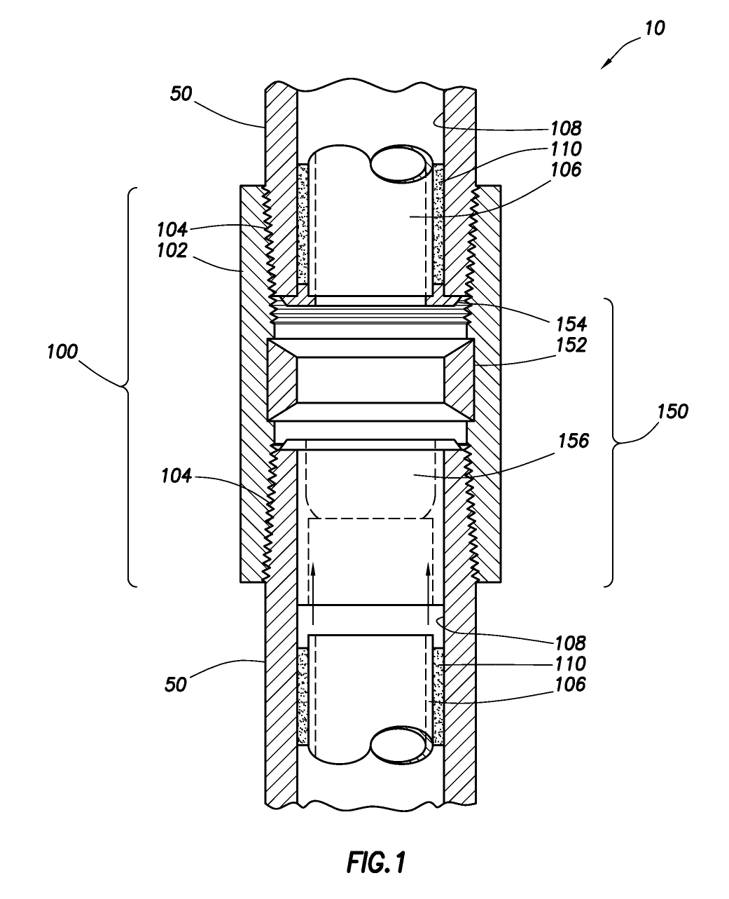

FIG. 1 shows a schematic view (partially in cross-section) of a portion of the tubing string 10. This portion includes a pair of pipes 50 connected by a coupling system 100. The coupling system 100 includes a conventional coupling 102 for threadedly connecting the threaded male ends 104 of the pipes 50. The coupling may be a conventional coupling known in the art, such as a standard (e.g., API) or modified coupling. Examples of couplings used for coupling pipes are described in U.S. Pat. Nos. 5,689,871, 4,600,219, 3,266,821, 4,568,113, 3,266,821, 2,805,827, and 2,487,241.

The tubing string 10 and coupling system 100 of FIG. 1 may be used in a variety of fluid transportation applications, such as for the transport of hydrocarbons. In some cases, the tubing string 10 may be part of a production system for producing hydrocarbons from a subsurface formation and to a surface unit for collection. Depending on the application, the pipe may be a production tubing, injection tubing, drill pipe, casing, landing string, cross-over sub, or other tubular. The ends of each pipe may have standard, API or a desired threading for providing a threaded connection as desired.

Each pipe 50 may be provided with a liner 106 on an inner surface 108 therein. The liner 106 may or may not be adhered to the inner surface 108 using an adherent, such as cement 110 as shown. Only a portion of each pipe 50, liner 106 and cement 110 is depicted. The liner 106 may extend the entire length of the inner surface 108 of the pipe 50.

The coupling system 100 also includes a lining system 150 made up of a compression ring 152, a tubular flange sleeve 154, and a tubular flexible sleeve 156. The compression ring 152 is a cylindrical ring positionable along an inner surface of the coupling 102. The compression ring 152 may be a conventional corrosion barrier (e.g., PTFE or other ring). The compression ring 152 may be made of a material, such as polyetheretherketone (peek), glass reinforced epoxy, polytetrafluoroethylene (PTFE) or other material, positionable between the ends 104 of the pipes 50 for compression therebewteen. The coupling 102 may optionally he provided with a pocket (not shown) for receiving at least a portion of the compression ring 152.

The flange sleeve 154 and flexible sleeve 156 are positioned on opposite sides of the compression ring 152. Each of the sleeves 154, 156 is positioned between the compression ring 152 and one of the pipes 50. The sleeves 154, 156 may be ring-shaped members made of an elastomeric, thermoplastic, injection molded, heat moldable, high strength, heat stabilized and/or other material (such as TEFLON™, glass reinforced, rubber, polythalamide, etc.) that permits flexibility, prevents cracking and absorbs loads during operation.

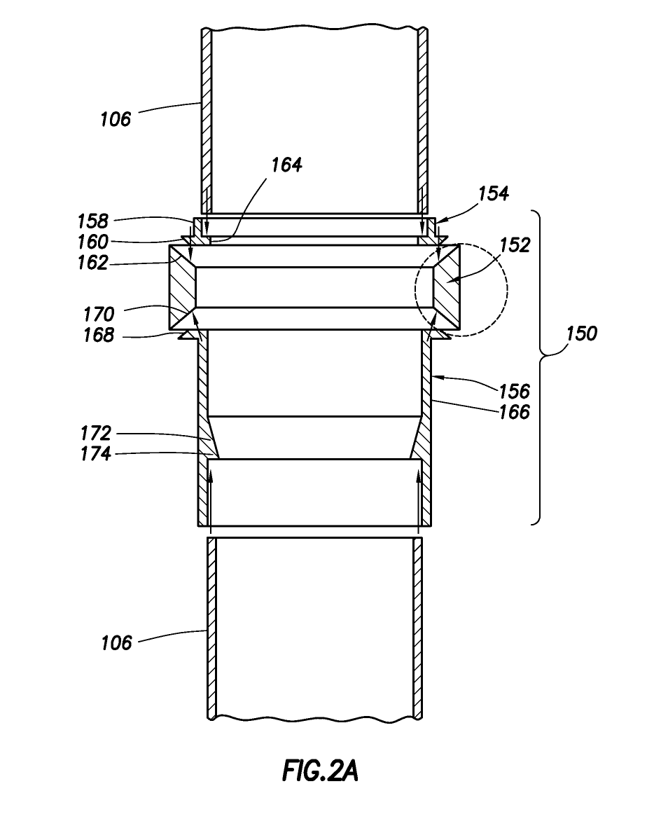

FIG. 2A shows a longitudinal, partial cross-sectional view of the lining system 150 positioned adjacent liners 106 of the pipes 50 (FIG. 1). As shown in FIGS. 1 and 2A, the compression ring 152, the flange sleeve 154 and the flexible sleeve 156 fit together for cooperative operation therebetween. A portion of the sleeves 154, 156 may be positioned with the compression ring 152 for compression between the ends 104 of the pipes 50.

The flange sleeve 154 (shown in cross-section) is positioned between the compression ring 152 and the liner 106 of the uphole pipe 50. The flexible sleeve 156 (not shown in cross-section) is positioned between the compression ring 152 and the liner 106 of the downhole pipe 50. The flange sleeve 154 and flexible sleeve 156 abut the compression ring 152. This configuration provides a barrier to flow that permits the compression ring 152 and sleeves 154, 156 to selectively deform and may or may not permit the passage of fluid therebetween as the pipes 50 and coupling system 100 are in operation. This selective leakage of fluid may be used to equalize pressure by selectively permitting leakage of fluid therethrough as pressure increases. The selective release of fluid through the lining system may be used to reduce pressure in the tubular string and reduce the potential for failures. This selective release of fluid may also he used to permit only a select amount of fluid therethrough td reduce the potential for corrosion.

The flange sleeve 154 has a ring body 158 with a flange ring 160 extending therefrom. The flange ring 160 seats against a ring shoulder 162 of the compression ring 152. The flange ring 160 also has a flange shoulder 164 extending about an inner diameter of the flange sleeve 154. The liner 106 extends the length of the pipe 50 and along the male end 104 to meet the flange sleeve 154. A portion of the liner 106 may be inserted into the flange sleeve 154 and seated against the flange shoulder 164 as indicated by the arrows. Optionally, the liner 106 may be integral with or pre-affixed to the flange sleeve 154. Cement 110 (or other possible adherent) may be provided about the liner 106 and flange sleeve 154 to secure them in position in the pipe 50.

The flexible sleeve 156 has a rine body 166 with an end-face 168 extending therefrom. The end-face 168 seats against a ring shoulder 170 of the compression ring 152. The end-face 168 may be similar to the flange ring 160. The ring body 166 may extend inwardly to define a shoulder portion 172 a distance from the end-face 168. The ring body 166 extends inwardly at the shoulder portion 172 to form a flex shoulder 174 along an inner diameter of the ring body 166. A portion of the liner 106 is insertable into the flexible sleeve 156 and seated against the flex shoulder 174 as indicated by the arrows. Optionally, the liner 106 may be integral with or pre-affixed to the flexible sleeve 156. Cement 110 (or other adherent) may be provided about the liner 106 and flexible sleeve 156 to secure them in position in the pipe 50.

The compression ring 152 is depicted as having shoulders 162 and 170 for receiving the flange ring 160 and the end-face 168 for contact therebetween. The shoulders 162 and 170 may have a linear, sloped shape as shown in FIG. 2A and/or a curved shape as shown in FIGS. 2B and 2C to receive and/or engage the flange ring 160 and/or end-face 168. The shoulders 162 and 170 may also be symmetrically positioned along the compression ring as shown in FIG. 2A. As shown in FIGS. 2B and 2C, in some applications, the compression ring 152 may have differently shaped (or asymmetric) shoulders to conform to flange, flex or other rings abutted thereto. The shape of the shoulders of the compression ring 152, flex ring and/or flange ring 160 may be configured to permit the selective passage of fluid and/or pressure therebetween.

The flexible sleeve 156 is configured to absorb loads applied thereto. Preferably, the shape, thickness and material of the flexible sleeve 156 (even at the shoulder portion 172) provide sufficient stability and flexibility to absorb the loads. The length of the liner 106 may extend along the pipe and terminate a distance from the male end 104 of the pipe 50. The flexible sleeve 156 may extend a distance into the pipe 50 to meet the liner 106. The flexible sleeve 156 may extend a distance into the pipe sufficient to alleviate loads passing through the coupling system 100 and/or pipes. This configuration is designed to allow the flexible sleeve 156 to absorb loads while reducing loads from the coupling system 100 and/or pipes 50. For example, the flexible sleeve 156 may alleviate hoop loads and hoop stresses at make up that may damage or crack the liner. The configuration of the compression ring 152 and sleeves 154, 156 may be provided to permit flexion as necessary to support the system and absorb or distribute loads.

While the flange sleeve 154 and the flexible sleeve 156 are depicted in a specific configuration about the compression ring 152, it will be appreciated that a combination of one or more flange sleeves 154 and/or flexible sleeves 156 may be provided. The length, thickness and material of the sleeves may be selected as desired to achieve the desired load reduction.

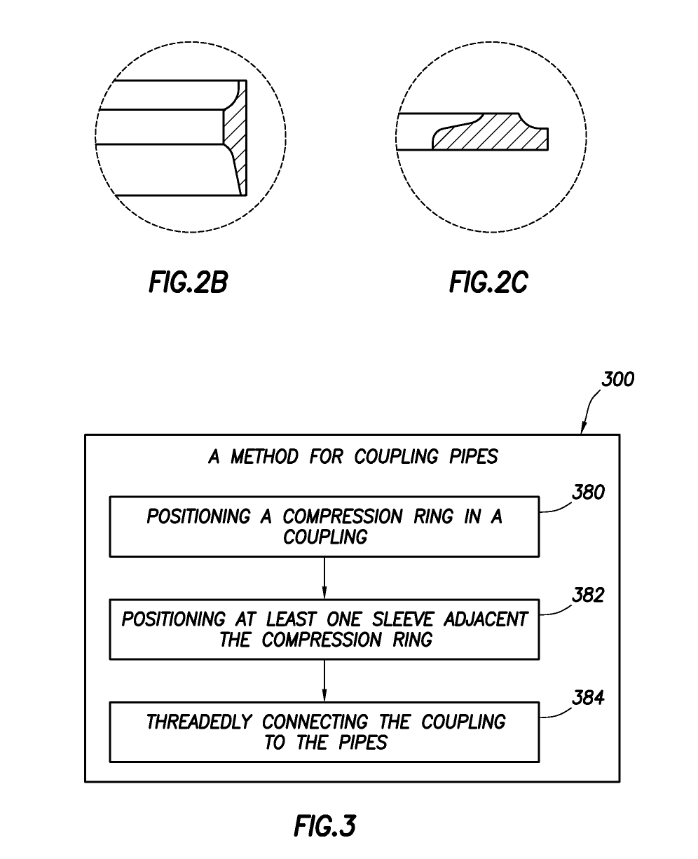

FIG. 3 is a flowchart depicting a method 300 for coupling pipes, such as the pipes 50 of FIG. 1. The method involves positioning (380) a compression ring in a coupling, positioning (382) at least one sleeve adjacent the compression ring, and threadedly connecting (384) the coupling to the pipes.

Additional steps may also be performed, such as applying torque to the pipes and/or coupling; inserting a liner into the pipe(s); securing the coupling, compression ring, sleeve(s) and/or liner into position using (for example, a filler or adherent); extending the sleeve(s) a distance into the pipe(s); and/or positioning a liner in the sleeve(s).

The steps of the method may be performed in a desired order. In an example assembly operation, a first sleeve (154 or 156) may be positioned in a first pipe (50), a first liner (106) in the first pipe may be seated in the first sleeve; the first sleeve and/or first liner may be secured into position; a compression ring (152) may be positioned in the coupling (102) and the coupling then threaded onto the first pipe end (104). This ‘pre-loaded’ pipe may then be transported to a wellsite for installation. A second sleeve (the other 156 or 154) may be positioned in a second pipe (50) and the coupling (102) threadedly connected to the second pipe end (104). During operation, fluid may be passed through the sleeves and compression ring in the pipes and the coupler. As fluid passes, fluid (which may he under pressure) may be selectively released between the ring shoulder and the sleeve(s). Variations on the order of assembly may be provided.

It will be appreciated by those skilled in the art that the techniques disclosed herein can be implemented for automated/autonomous applications via software configured with algorithms to perform the desired functions. These aspects can be implemented by programming one or more suitable general-purpose computers having appropriate hardware. The programming may be accomplished through the use of one or more program storage devices readable by the processor(s) and encoding one or more programs of instructions executable by the computer for performing the operations described herein. The program storage device may take the form of, e.g., one or more floppy disks; a CD ROM or other optical disk; a read-only memory chip (ROM); and other forms of the kind well known in the art or subsequently developed. The program of instructions may be “object code,” i.e., in binary form that is executable more-or-less directly by the computer; in “source code” that requires compilation or interpretation before execution; or in some intermediate form such as partially compiled code. The precise forms of the program storage device and of the encoding of instructions are immaterial here. Aspects of the disclosure may also be configured to perform the described functions (via appropriate hardware/software) solely on site and/or remotely controlled via an extended communication (e.g., wireless, interact, satellite, etc.) network.

While the present disclosure describes specific aspects of the disclosure, numerous modifications and variations will become apparent to those skilled in the art after studying the disclosure, including use of equivalent functional and/or structural substitutes for elements described herein. For example, aspects of the disclosure can also be implemented for using one or more flexible sleeves, flange sleeves, compression rings, liners, etc. While a specific orientation is shown in FIGS. 1-2A, it will be appreciated that the coupling system may be used as shown, or inverted. All such similar variations apparent to those skilled in the art are deemed to be within the scope of the disclosure as defined by the appended claims.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A liner system for a tubular string comprising a coupling threadedly connectable to a pair of pipes for forming a threaded connection therebetween, the liner system comprising:
at least one tubular sleeve positionable in at least one of the pair of pipes, each of the at least one tubular sleeves having a ring end; and
a compression ring positionable in the coupling, the compression ring having a ring shoulder positionable adjacent a ting end of the at least one tubular sleeve for selective engagement therewith such that, as fluid passes through the compression ring and the at least one tubular sleeve, fluid is selectively releaseable therebetween.

2. The liner system of claim 1, further comprising a liner positionable in each of at least one of the pair of pipes, the liner extending through at least a portion of the at least one tubular sleeve.

3. The liner system of claim 1, wherein the at least one tubular sleeve comprises a liner extending therefrom and into one of the pipes.

4. The liner system of claim 1, wherein the compression ring has a linear cross-section.

5. The liner system of claim 1, wherein the compression ring has a curved cross-section.

6. The liner system of claim 1, wherein the compression ring has an asymmetrical cross-section.

7. The liner system of claim 1, wherein the at least one tubular sleeve comprises a flange sleeve having a ring body with a flange ring at the ring end thereof, each of the flange rings being positionable adjacent one of the ring shoulders of the compression ring.

8. The liner system of claim 7, wherein the flange ring defines a flange shoulder about an inner diameter of the flange sleeve for receivingly engaging a liner.

9. The liner system of claim 1, wherein the at least one tubular sleeve comprises a flexible sleeve having a ring body with an end face at the ring end thereof, the end face of the flexible sleeve positionable adjacent one of the ring shoulders of the compression ring.

10. The liner system of claim 9, further comprising a shoulder portion on an inner diameter thereof defining a flexible shoulder for receivingly engaging a liner.

11. The liner system of claim 1, further comprising a bonding agent for securing the at least one tubular sleeve in place.

12. The liner system of claim 11, wherein the bonding agent comprises one of a cement, an adherent and combinations thereof.

13. The liner system of claim 1, wherein the at least one tubular sleeve comprises a pair of sleeves, each of the pair of sleeves positionable adjacent one of the ring shoulders of the compression ring.

14. The liner system of claim 1, wherein the at least one tubular sleeve comprises one of polyetheretherketone, glass reinforced epoxy, polytetrafluoroethylene, elastomer, thermoplastic, glass reinforced, rubber, polythalamide, and combinations thereof.

15. A system for coupling a pair of pipes of a tubular string, comprising:
a coupling threadedly connectable to the pair of pipes for forming a threaded connection therebetween; and
a liner system comprising:
at least one tubular sleeve positionable in at least one of the pair of pipes, each of the at least one tubular sleeves having a ring end; and
a compression ring positionable in the coupling, the compression ring having a ring shoulder positionable adjacent a ring end of the at least one tubular sleeve for selective engagement therewith such that, as fluid passes through the compression ring and the at least one tubular sleeve, fluid is selectively releaseable therebetween.

16. The system of claim 15, further comprising a liner positionable in each of the plurality of pipes.

17. The system of claim 16, wherein the liner extends into at least a portion of the at least one tubular sleeve.

18. The system of claim 15, further comprising a bonding agent for bonding the at least one tubular sleeve in place.

19. A method for coupling a pair of pipes of a tubular string, comprising:
providing a coupling threadedly connectable to the pair of pipes and a liner system comprising a compression ring and at least one tubular sleeve;
inserting the at least one tubular sleeve in at least one of the pair of pipes;
threadedly connecting the coupling to one of the pair of pipes;
inserting the compression ring into the coupling such that a ring shoulder of the compression ring is pressed against the at least one tubular sleeve;
threadedly connecting another of the pair of pipes to the coupling; and
selectively releasing fluid between the ring shoulder and the at least one tubular sleeve as fluid passes through the liner system.

20. The method of claim 19, further comprising inserting at least one liner in the pair of pipes.

21. The method of claim 20, further comprising inserting the at least one liner into the at least one tubular sleeve.

22. The method of claim 20, further comprising positioning the at least one liner against a shoulder of the at least one tubular sleeve.

23. The method of claim 19, further comprising passing fluid under pressure through the pipes and the liner system.

24. The method of claim 19, further comprising applying a bonding to the liner system.
